(19) United States
(12) Patent Application Publication
(10) Pub. No.: US 2013/0120546 A1
(43) Pub. Date: May 16, 2013

(54) STEREOSCOPIC DISPLAY SYSTEM AND DRIVING CONTROL METHOD THEREOF

(71) Applicants: Si-Duk SUNG, Yongin-City (KR); Baek-Woon LEE, Yongin-City (KR); Jong-Hwa PARK, Yongin-City (KR)

(72) Inventors: Si-Duk SUNG, Yongin-City (KR); Baek-Woon LEE, Yongin-City (KR); Jong-Hwa PARK, Yongin-City (KR)

(21) Appl. No.: 13/650,355

(22) Filed: Oct. 12, 2012

(30) Foreign Application Priority Data
Nov. 15, 2011 (KR) 10-2011-0119008

(51) Int. Cl. H04N 13/04

(52) U.S. Cl. 348/56; 348/E13.075

(57) ABSTRACT

A stereoscopic display system and a driving control method thereof are provided. The stereoscopic display system comprises a display device displaying images by dividing a first field and a second field in one image frame, and shutter spectacles controlling opening and closing of a binocular shutter corresponding to a light emitting period of a binocular view point image of the first field and the second field, and wherein the binocular shutter is closed earlier than a finishing point of each light emitting period of the binocular view point image by a first period.

### CROSS-REFERENCE TO RELATED APPLICATION

This application claims priority to and the benefit of Korean Patent Application No. 10-2011-0119008 filed in the Korean Intellectual Property Office on Nov. 15, 2011, the entire contents of which are incorporated herein by reference.

### BACKGROUND

1. Field

Example embodiments relate to a stereoscopic display system and a driving control method thereof. More particularly, example embodiments relate to a system displaying a stereoscopic effect of an image using shutter spectacles and a driving control method thereof.

2. Description of the Related Art

Various methods in a stereoscopic display method for stereoscopically realizing a display image by using a display device have been developed.

In general, the factors for a person to perceive a stereoscopic effect include a biological factor and an experimental factor, and the stereoscopic display skill expresses the stereoscopic effect of an object by using binocular parallax, i.e., a factor in recognizing the stereoscopic effect at a short distance. As a method for displaying the stereoscopic effect of the object, shutter spectacles may be used.

That is, left eye and right eye disparity images are time-divisionally divided and displayed under the display device, and opening and closing of a left eye shutter and a right eye shutter of the shutter spectacles is alternately performed in synchronization with the conversion between the images to divide the disparity image to a left eye and a right eye, thereby using binocular disparity generated according thereto.

However, in the case of alternately closing and opening the left eye and the right eye of the shutter spectacles, a difference of the image quality of the disparity image may be generated according to a response characteristic of each shutter in reaction to the control signal, thereby causing deterioration of a stereoscopic motion picture.

The above information disclosed in this Background section is only for enhancement of understanding of the background of the invention and therefore it may contain information that does not form the prior art that is already known in this country to a person of ordinary skill in the art.

### SUMMARY

According to an exemplary embodiment, a stereoscopic display system may compensate for an image quality difference of disparity images and for deterioration of an overall image quality according to a delay of a response time of shutter spectacles.

Also, according to an exemplary embodiment, a driving control method of a stereoscopic display system may control a response speed of shutter spectacles, such that deterioration of the entire stereoscopic image may be compensated and control of luminance deviation between each disparity image of a stereoscopic motion picture according to a convention of a user may be provided.

A stereoscopic display system according to an exemplary embodiment of the may include a display device configured to display an image by dividing a first field and a second field in one image frame, the first field including a first light emitting period for light-emitting according to an image data signal of a first view point and a second light emitting period for light-emitting according to an image data signal of a second view point, and the second field including a third light emitting period for light-emitting according to a image data signal of the first view point and a fourth light emitting period for light-emitting according to an image data signal of the second view point, and shutter spectacles having a first view point shutter and a second view point shutter, the first and second view point shutters being configured to open and close in accordance with a shutter control signal transmitted from the display device. The first view point shutter is closed earlier than a finishing point of each of the first and third light emitting periods by a first period, and the second view point shutter is closed earlier than a finishing point of each of the second and fourth light emitting periods by the first period.

The first period may be equal to or longer than a delay time according to a response speed of the first view point shutter and the second view point shutter.

The display device may include a first pixel group including a plurality of first pixels and a second pixel group including a plurality of second pixels, and the first pixel group may be simultaneously light-emitted during the first light emitting period and the second light emitting period, and the second pixel group is simultaneously light-emitted during the third light emitting period and the fourth light emitting period.

The first view point shutter may be opened equally to or before the start time of the light emitting period that is firstly started among the first light emitting period and the third light emitting period, and the second view point shutter may be opened equally to or before the start time of the light emitting period that is firstly started among the second light emitting period and the fourth light emitting period.

The first light emitting period and the third light emitting period may not overlap each other, and the second light emitting period and the fourth light emitting period may not overlap each other.

The first field may further include a reset period for resetting an anode voltage of each organic light emitting diode (OLED) of the pixels of the first pixel area before the first light emitting period and the second light emitting period, a compensating period for compensating a threshold voltage of each driving transistor of the pixels of the first pixel area, and a scan period for transmitting the image data signal of the first view point or the image data signal of the second view point.

The second field may include a reset period for resetting an anode voltage of each OLED of the pixels of the second pixel area before the third light emitting period and the fourth light emitting period, a compensating period for compensating a threshold voltage of each driving transistor of the pixels of the second pixel area, and a scan period for transmitting the image data signal of the first view point or the image data signal of the second view point.

In the first to fourth light emitting periods, a difference of voltage levels of the first power source voltage and the second power source voltage supplied to the pixels of the first pixel area or the pixels of the second pixel area may be controlled differently from the remaining period to be supplied.

The first pixel area may include a plurality of first pixels, the second pixel area may include a plurality of second pixels, and the plurality of first pixels and the plurality of second pixels may be alternately arranged according to a first direction and a second direction. An arrangement of these pixels is not limited thereto.

The display device may include a signal controller generating the shutter control signal controlling the opening and closing of the first view point shutter and the second view point shutter of the shutter spectacles corresponding to the start or the finishing point of the first to fourth light emitting periods and transmitting the shutter control signal to the shutter spectacles.

The display device may further include a transceiver transmitting information to the outside through a wire or wireless communication method, and the shutter control signal may be transmitted to the shutter spectacles from the signal controller through the transceiver.

The display device may include a display unit including the first pixel area including the plurality of first pixels and the second pixel area including the plurality of second pixels, wherein the plurality of first pixels and second pixels respectively include an OLED and a driving transistor controlling a driving current supplied to the OLED, a scan driver transmitting a plurality of scan signals to a plurality of scan lines connected to the plurality of first pixels and second pixels, a data driver transmitting the plurality of first view point image data signals and second view point image data signals to a plurality of data lines connected to the plurality of first pixels and second pixels, a power controller controlling and transmitting a first power source voltage and a second power source voltage as a voltage for driving the plurality of first pixels and second pixels, and a signal controller controlling the scan driver, the data driver, and the power controller, generating and supplying the plurality of first view point image data signals and second view point image data signal to the data driver, and generating and transmitting the shutter control signal controlling the opening and closing of the first view point shutter and the second view point shutter of the shutter spectacles to the shutter spectacles.

The display device may further include a transceiver receiving the shutter control signal from the signal controller and transmitting the shutter control signal to the shutter spectacles through the wire or wireless communication method.

The stereoscopic display system may further include a remote controller generating a remote control signal controlling luminance of the display image of the display device to a luminance level selected by a user and transmitting the remote control signal to the display device.

The remote control signal may be transmitted to the signal controller through the transceiver of the display device, and controls the driving timing of the shutter control signal generated by the signal controller.

A driving control method of a stereoscopic display system according to an exemplary embodiment of the example embodiments includes: driving a first field sequentially including a first image period transmitting a image data signal of a first view point to pixels of the first pixel area among the plurality of pixels and simultaneously light-emitting according to the data signal, and a second image period transmitting an image data signal of a second view point and simultaneously light-emitting according to the data signal; driving a second field sequentially including a third image period transmitting the image data signal of a first view point to pixels of the first pixel area among the plurality of pixels and simultaneously light-emitting according to the data signal and a fourth image period transmitting the image data signal of a second view point and simultaneously light-emitting according to the data signal; and driving the shutter spectacles such that the first view point shutter is opened at the light emitting period of the first image period and the third image period, and the second view point shutter is opened at the light emitting period of the second image period and the fourth image period.

A start time of the third image period may be shifted by a predetermined period after the start time of the first image period. The first view point shutter may be closed before a light emitting finishing point of the third image period by the second period, and the second view point shutter may be closed before the light emitting finishing point of the fourth image period by the second period.

The second period may be equal to or longer than a delay time according to a response speed of the first view point shutter and the second view point shutter.

The first image period to the fourth image period may respectively include a reset period for resetting an anode voltage of each organic light emitting diode (OLED) of the plurality of pixels, a compensating period for compensating a threshold voltage of each driving transistor of the plurality of pixels, a scan period for transmitting the image data signal of the corresponding view point, and a light emitting period for simultaneously light-emitting the plurality of pixels according to the image data signal of the corresponding view point.

The driving control method may further include generating a remote control signal for controlling luminance of the display image of the display device as a luminance level selected by the user and transmitting the remote control signal to the display device before driving the shutter spectacles.

According to the example embodiments, the image quality difference of the disparity image and the deterioration of the entire image quality are compensated by considering the response characteristic of the shutter spectacles such that excellent image quality of the stereoscopic may be obtained in the stereoscopic display system.

Also, the luminance deviation between each disparity image of the stereoscopic motion picture may be controlled for the convenience of the user such that the operation control of the stereoscopic display system may be easily obtained and various.

### BRIEF DESCRIPTION OF THE DRAWINGS

FIG. 1 is a block diagram of a stereoscopic display system according to an exemplary embodiment.

FIG. 2 is a block diagram of a display device of a stereoscopic display system according to an exemplary embodiment.

FIG. 3 is an operation timing diagram of a stereoscopic display system according to an exemplary embodiment.

FIG. 4 is a view of an image for a pixel area divided with disparity and displayed in a stereoscopic display system according to an exemplary embodiment.

FIG. 5 is an operation timing diagram of a stereoscopic display system according to various exemplary embodiments.

### DETAILED DESCRIPTION

Example embodiments will be described more fully hereinafter with reference to the accompanying drawings, in which exemplary embodiments are shown. As those skilled in the art would realize, the described embodiments may be modified in various different ways, all without departing from the spirit or scope of the example embodiments.

Further, the same constituent elements in exemplary embodiments are given the same reference numerals and will be described representatively in a first exemplary embodiment, and only different configurations from the first exemplary embodiment will be described in the other exemplary embodiments.

The drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element, “electrically coupled” to the other element, or intervening elements may also be present. In addition, unless explicitly described to the contrary, the word “comprise” and variations such as “comprises” or “comprising” will be understood to imply the inclusion of stated elements but not the exclusion of any other elements.

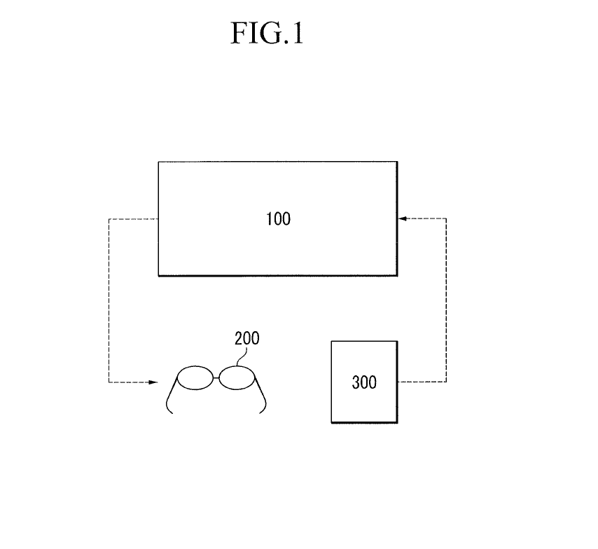

FIG. 1 is a block diagram of a stereoscopic display system according to an exemplary embodiment.

Referring to FIG. 1, a stereoscopic display system of the example embodiments includes a display device 100 displaying and driving a three-dimensional (3D) motion picture in a stereoscopic form, shutter spectacles 200 generating a binocular disparity, i.e., a binocular parallax, between a left eye and a right eye to identify a stereoscopic effect of an image displayed by the display device 100, and a remote controller 300 generating and transmitting a control signal to the display device 100 to arbitrarily control a deviation of stereoscopic luminance of the display device 100 by a user.

The display device 100 is a display device displaying and time-divisionally driving a left-eye image transmitted to a left eye shutter of the shutter spectacles 200 and a right-eye image transmitted to a right eye shutter of the shutter spectacles 200 for displaying the stereoscopic image, and it is not limited to a kind thereof. In general, there are various display devices, e.g., a liquid crystal display (LCD) display an image through a liquid crystal layer and an organic light emitting diode (OLED) display displaying an image by using an OLED.

The shutter spectacles 200 include a left eye shutter receiving the left-eye image recognized by the left eye of the user and a right eye shutter receiving the right-eye image recognized by the right eye of the user. The left eye shutter and the right eye shutter receive a shutter control signal from the display device 100 to control the opening and closing thereof.

Conventionally, in a conventional stereoscopic display device displaying the stereoscopic effect by using the disparity image time-divided by the opening and closing of the shutter spectacles, light emitted to display an image may be partially lost due to the response speed of the opening and closing of the right eye and the left eye of the shutter spectacles, thereby generating deterioration of the image quality. The stereoscopic display system of the example embodiments may provide an improved control of the shutter control signal, i.e., in accordance with the response speed of the shutter spectacles 200, to prevent the deterioration of the image quality of the stereoscopic image displayed in the display device 100.

The remote controller 300 is a means that is wirelessly connected to the display device 100 and transmits a signal or information. The remote controller 300 generates and transmits a remote control signal to the display device 100, such that the user may arbitrarily regulate and control the luminance deviation in the display screen of the display device 100. The remote control signal controls the driving timing of the shutter control signal, which in turn, controls the opening and closing of the shutter spectacles 200 through the display device 100.

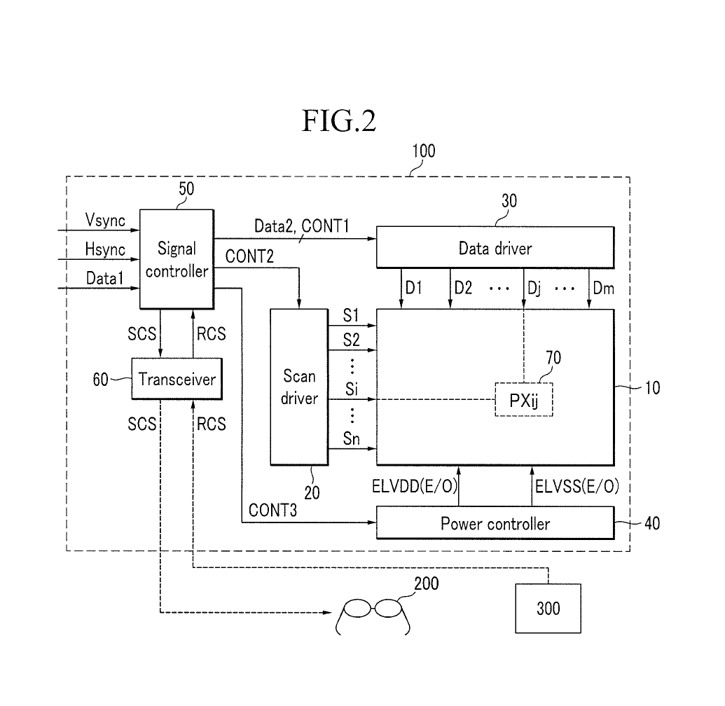

FIG. 2 is a block diagram of the display device 100 of a stereoscopic display system according to an exemplary embodiment. Referring to FIG. 2, the display device 100 includes a display unit 10, a scan driver 20, a data driver 30, a power controller 40, a signal controller 50, and a transceiver 60.

The display unit 10 includes a plurality of pixels 70, and each pixel emits light to display an image corresponding to a video signal input from the outside.

The scan driver 20 is controlled by the signal controller 50, and applies a scan signal corresponding to a plurality of scan lines S1-Sn connected to the display unit 10 for a predetermined cycle (e.g., a horizontal synchronization signal (Hsync) cycle). The pixels of the display unit 10 that are respectively connected to the plurality of scan lines S1-Sn are activated by the scan signals corresponding to the plurality of scan lines S1-Sn.

The data driver 30 is controlled by the signal controller 50, and applies a data signal to a plurality of data lines D1-Dm connected to the display unit 10 for a predetermined cycle (e.g., a vertical synchronization signal (Vsync) cycle). If a data signal Data2 corresponding to an external video signal Data1 applied to a plurality of data lines D1-Dm are respectively transmitted to the plurality of pixels 70 of the display unit 10, the plurality of pixels 70 display the image while emitting the light by the driving current corresponding to the data signal Data2.

The power controller 40 is controlled by the signal controller 50, and generates and transmits the voltage for driving the plurality of pixels 70 included in the display unit 10. For example, the power controller 40 generates and applies a first power source voltage ELVDD and a second power source voltage ELVSS to the plurality of pixels 70.

In the stereoscopic display system according to an exemplary embodiment, the first power source voltage ELVDD and the second power source voltage ELVSS may be respectively applied according to the pixel driving method of the display unit 10, while dividing the pixel area of the display unit 10. That is, when dividing the pixel area of the display unit 10 into a first region E including a first plurality of pixels and a second region O including a second plurality of pixels, i.e., pixels not included in the first region E, the power controller 40 may generate the first power source voltage ELVDD_E applied to the first region E, the first power source voltage ELVDD_O applied to the second region O, the second power source voltage ELVSS_E applied to the first region E, and the second power source voltage ELVSS_O applied to the second region O.

In the stereoscopic display system of the example embodiments, the display unit 10 of the display device 100 may be driven to differently extinguish and emit the light for the pixel areas E/O in one image frame. Particularly, for driving and controlling the extinction and the light emission of a plurality of pixels included in the pixel area E/O, the first power source voltage ELVDD_E/O and the second power source voltage ELVSS_E/O respectively applied to the pixel area E/O may have a first level voltage (e.g., a high level voltage of logic “1”) and a second level voltage (e.g., a low level voltage of logic “0”) at least two times in one image frame. At this time, one image frame may be one left-eye image frame or one right-eye image frame for the stereoscopic display.

When the display device 100 is an OLED display having the display unit 10 including pixels emitting light by using OLEDs, each OLED in a respective pixel emits light in accordance with current flowing from a terminal applied with the first power source voltage ELVDD_E/O to a terminal applied with the second power source voltage ELVSS_E/O. The current does not flow from the terminal applied with the first power source voltage ELVDD_E/O to the terminal applied with the second power source voltage ELVSS_E/O when the state of the second power source voltage ELVSS_E/O is at a high level, e.g., at that state the OLED is extinguished. Also, the current flows from the terminal applied with the first power source voltage ELVDD_E/O to the terminal applied with the second power source voltage ELVSS_E/O when the state of the second power source voltage ELVSS_E/O is at a low level, e.g., at that state the OLED may emit light. If each pixel area of the display unit 10 is driven and controlled as discussed above, the pixel area may simultaneously extinguish and emit light in the left-eye image frame or the right-eye image frame. The image data signal is sequentially written in one left-eye image frame or one right-eye image frame and the light is simultaneously emitted for the pixel area, and the light is extinguished and the light is simultaneously emitted for the pixel area when the data signal is written.

Meanwhile, the signal controller 50 receives the video signal Data1, the vertical synchronization signal Vsync, and the horizontal synchronization signal Hsync from the outside, transmits the image data signal Data2 corresponding to the video signal Data1 to the data driver 30, and generates and transmits a control signal controlling each constitution of the display device 100.

In detail, the signal controller 50 generates a scan driving control signal CONT2 controlling the scan driver 20 and transmits it to the scan driver 20. Thus, the scan driver 20 may be controlled to apply the scan signal to the display unit 10 every predetermined cycle (e.g., horizontal synchronization signal (Hsync) cycle).

Also, the data driving control signal CONT1 controlling the data driver 30 is generated and is transmitted to the data driver 20 along with the image data signal Data2. Thus, the data driver 30 may be controlled to apply the image data signal to the display unit 10 every predetermined cycle (e.g., the vertical synchronization signal (Vsync) cycle).

Also, the signal controller 50 generates the power control signal CONT3 controlling the power controller 40 and transmits it the power controller 40. Thus, the power controller 40 may be controlled to apply the first power source voltage ELVDD and the second power source voltage ELVSS to the pixel area of the display unit 10. Accordingly, the power controller 40 may apply the first power source voltage ELVDD_E and ELVDD_O to the pixel area and the second power source voltage ELVSS_E and ELVSS_O to the pixel area.

As described above, the display device 100 of the stereoscopic display system according to an exemplary embodiment simultaneously performs the extinguishment and the light emitting in one image frame for the pixel area. As such, the power controller 40 controls the first power source voltage ELVDD_E and ELVDD_O or the second power source voltage ELVSS_E and ELVSS_O into the voltage of the high level or the low level corresponding to the power control signal CONT3 to apply them to each pixel of the display unit 10. In further detail, the first power source voltage ELVDD_E and the second power source voltage ELVSS_E applied to the first pixel area E in one left eye image frame or one right-eye image frame may be controlled and applied to have the difference of the voltage level in the reset period, a compensating period in which a threshold voltage of the driving transistor of the pixel is compensated, and an extinguishment period including a scan period in which the data voltage according to the image data signal is written.

For example, the second power source voltage ELVSS_E may be transmitted as the high level. Meanwhile, in the light emitting period in which the pixels of the first pixel area E simultaneously emit light according to the image data voltage according to the written data signal, the voltage level of the first power source voltage ELVDD_E and the second power source voltage ELVSS_E is controlled and applied to be large. For example, the first power source voltage ELVDD_E may be increased to the high level or the second power source voltage ELVSS_E may be decreased to the low level to be transmitted and applied.

In the exemplary embodiment of FIG. 2, it is assumed that the pixel area of the display unit 10 is two regions E/O and the first power source voltage and the second power source voltage are transmitted to the two regions. However, embodiments are not limited thereto.

Meanwhile, the signal controller 50 of the stereoscopic display system according to an exemplary embodiment is connected to the transceiver 60, such that the external shutter spectacles 200 and the remote controller 300 may exchange signals. The transceiver 60 may be a communication means for wire or wireless information transmission. For example, the transceiver 60 may be wirelessly connected to the external devices, i.e., communication means transmitting information, but it is not limited thereto.

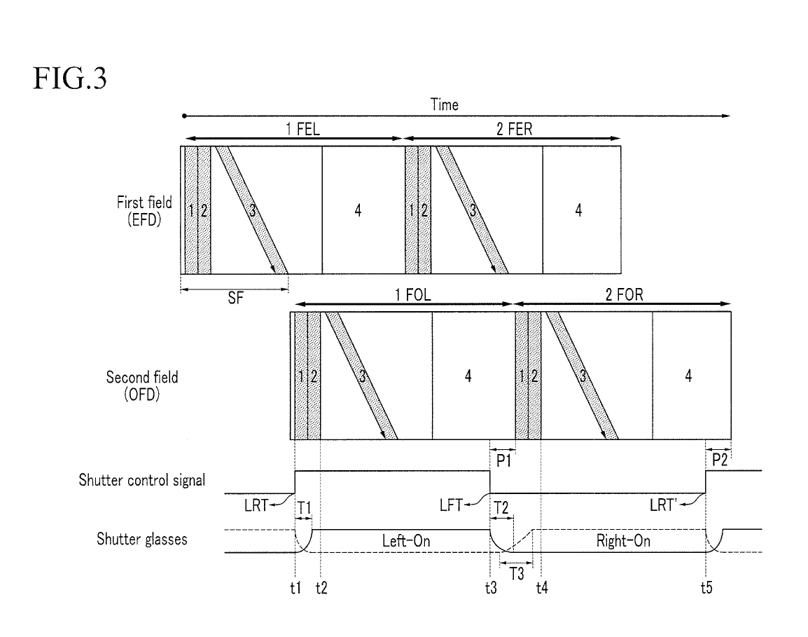

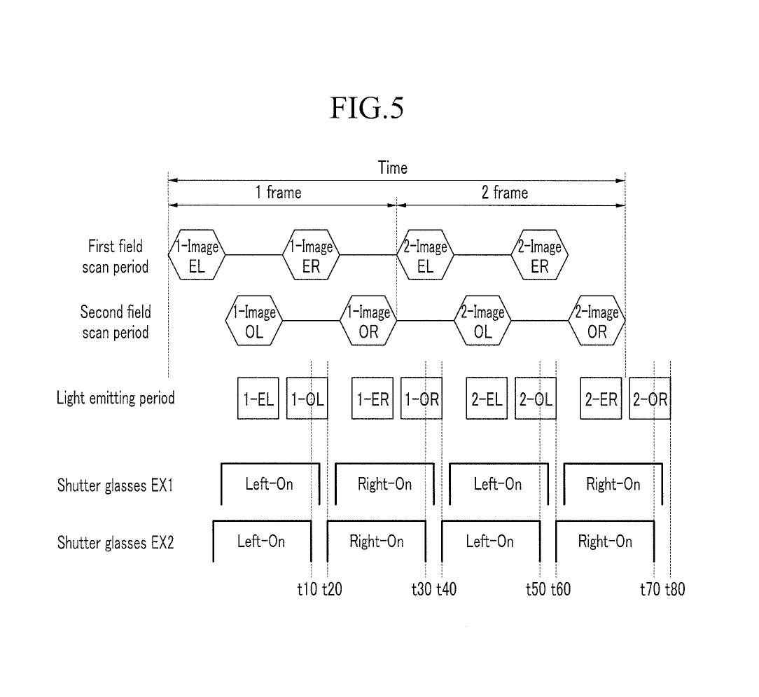

In detail, the transceiver 60 is connected to the shutter spectacles 200 of the stereoscopic display system of the example embodiments to transmit a shutter control signal SCS. That is, the shutter control signal SCS is generated and transmitted to the transceiver 60, such that the opening and closing of the left and right eye shutters of the shutter spectacles 200 may be controlled in accordance to the driving viewpoint of the light emission or extinguishment, e.g., dimming, for the pixel area of the display unit 10 in the signal controller 50. The transceiver 60 transmits the shutter control signal SCS to the external shutter spectacles 200 via a wire or wireless method. Thus, the left eye shutter and the right eye shutter of the shutter spectacles 200 are opened and closed in accordance with the shutter control signal SCS. An operation of the shutter control signal SCS, as well as opening and closing of the shutter spectacles 200, according to an exemplary embodiment will be described with reference to FIG. 3 and FIG. 5.

Meanwhile, the transceiver 60 is connected to the remote controller 300 outside the display device 100 with a wire or wireless method, thereby receiving a remote control signal RCS generated and transmitted by the remote controller 300. That is, the user may select a luminance level of a displayed image, i.e., an amount of light emitted by the display unit 10 of the display device 100, according to convenience, and the remote controller 300 may generate the remote control signal RCS to increase or decrease an existing luminance level within a predetermined period to correspond to the luminance level selected by the user. In the remote controller 300, the predetermined remote control signal RCS is transmitted to the transceiver 60 of the display device 100 by using a wire or wireless communication method, and the transceiver 60 may transmit the received remote control signal RCS to the signal controller 50. Thus, the shutter control signal SCS controlling the viewpoint of the left and the right eye shutters of the shutter spectacles 200 may be generated and transmitted according to the remote control signal RCS in the signal controller 50. As described above, the control signals are generated, cycled, and transmitted to the remote controller 300, the transceiver 60, the signal controller 50, and the shutter spectacles 200, such that the display luminance of the stereoscopic image of the display device 100 may be controlled for the user's convenience.

In another exemplary embodiment, the signal controller 50 may control the luminance of the stereoscopic image displayed in the display unit 10 by using a method for compensating the luminance of the image data signal Data2 transmitted to the data driver 30 according to the remote control signal RCS.

FIG. 3 is an operation timing diagram of a stereoscopic display system according to an exemplary embodiment. FIG. 5 shows various other exemplary embodiments.

FIG. 3 illustrates a method of driving for the pixel area in one left-eye image frame and one right-eye image frame. In FIG. 3, as described above, a first field EFD and a second field OFD are defined to indicate each pixel area when the pixel area of the display unit 10 is divided into the first region E and the second region O.

In detail, the stereoscopic display system according to an exemplary embodiment depends on the method of realizing the stereoscopic image by using the binocular disparity of the shutter spectacles, thereby the image data signal for the stereoscopic image is generated and processed, while the time is divided and seriated as the frame unit. One image frame includes a left-eye image frame recognized by the left eye of the user through the left eye shutter and the right-eye image frame recognized by the right eye of the user through the right eye shutter. Also, the left eye image data signal is processed and displayed during the left-eye image frame, and the right eye image data signal is processed and displayed during the right-eye image frame.

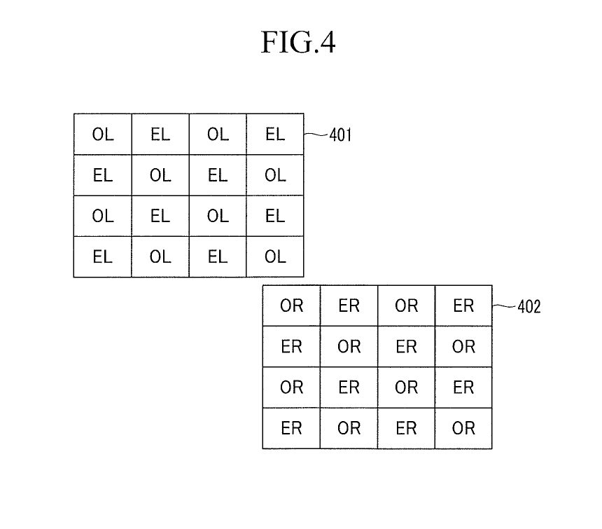

Accordingly, as shown in FIG. 4, the left-eye image 401 and the right-eye image 402 are displayed during one frame with the predetermined disparity. In further detail, the left-eye image 401 of FIG. 4 includes the left-eye image EL displayed in the first field and the left-eye image OL displayed in the second field. Likewise, the right-eye image 402 of FIG. 4 includes the right-eye image ER displayed in the first field and the right-eye image OR displayed in the second field.

Also, according to the driving method of the stereoscopic display system according to an exemplary embodiment, the display image of FIG. 4 is driven for the pixel area to display the image, and thereby the processes of writing and light emitting of the image data signal are performed during the left eye or the right-eye image frames for each field.

That is, referring to FIG. 3 and FIG. 4, the pixels included in the first field EFD and the second field OFD of the display unit 10 are written with the predetermined corresponding left eye image data signal, and display the left-eye image EL and OL according thereto during the left-eye image frame 1FEL and 1FOL. Also, the pixels included in the first field EFD and the second field OFD of the display unit 10 are written with the predetermined corresponding right eye image data signal, and display the right-eye image ER and OR according thereto during the right-eye image frame 2FER and 2FOR.

The extinguishment period and the light emitting period of the first field EFD and the second field OFD are formed while having a different predetermined temporal gap.

The extinguishment period of each field includes at least a reset period 1, a compensating period 2 compensating for the threshold voltage of each transistor of the pixels of the display unit, a scan period 3 activating the pixels of the display unit, and sequentially writing and storing the left eye image data signal or the right eye image data signal. At this time, the first field EFD and the second field OFD are driven with the temporal difference by a predetermined time SF. For example, as illustrated in FIG. 3, the second field OFD is driven in synchronization with the point of time that is moved by the predetermined time SF rather than the first field EFD.

The extinguishment period of the first field EFD and the second field OFD have the temporal difference by the predetermined time SF, such that the light emitting period 4 also has a difference of the same time. Accordingly, the image displayed through the light emitting period 4 among the left-eye image frame 1FEL of the first field EFD and the light emitting period 4 among the left-eye image frame 1FOL of the second field OFD appears like the left-eye image 401 of FIG. 4. Also, the image displayed through the light emitting period 4 among the right-eye image frame 2FER of the first field EFD and the light emitting period 4 among the right-eye image frame 2FOR of the second field OFD appears like the right-eye image 402 of FIG. 4.

At this time, the signal controller 50 generates the shutter control signal opening and closing the shutter spectacles 200 in synchronization with the light emitting period of each field and transmits it to the shutter spectacles 200 through the transceiver 60.

According to an exemplary embodiment, as illustrated in FIG. 3, the shutter control signal has a left eye raising edge LRT that is increased to the first level (for example, in the state that the logic value is 1) at the point of time t1, maintains the first level during a period of the point of time t1 to the point of time t3, and has a left eye falling edge LFT that is decreased to the second level (for example, a state that the logic value is 0) at the point of time t3. The shutter control signal has the left eye raising edge LRT′ at which the second level is maintained during the period of the point of time t3 to the point of time t5 and is again increased to the first level at the point of time t5 and repeats the first level and the second level.

During a period in which the shutter control signal maintains the first level, the left eye shutter of the shutter spectacles transmitted with the shutter control signal may be controlled to be opened and the right eye shutter may be controlled to be closed. Meanwhile, during a period in which the shutter control signal maintains the second level, the right eye shutter of the shutter spectacles transmitted with the shutter control signal may be controlled to be opened and the left eye shutter may be controlled to be closed.

The left eye raising edge LRT of the shutter control signal must be at least earlier than the point of time t2 as a start time of the light emitting period 4 of the first field EFD. Accordingly, the shutter control signal is not limited to the timing diagram of FIG. 3, and the left eye raising edge LRT that is increased to the first level is formed at the predetermined point of time between the period of the point of time t1 to the point of time t2.

By controlling the point of time of the left eye raising edge LRT of the shutter control signal, the delay due to the response speed, when the left eye shutter is opened in the shutter spectacles, may be compensated. For example, when the left eye shutter opening Left-On of the shutter spectacles is delayed by the period Ti, e.g., due to the response speed of the left eye shutter, the shutter control signal may be adjusted, e.g., time t1, to have time T1 before time t2, i.e., a start time of the light emitting period 4, of at least the first field EFD in order to compensate for the delay T1.

Meanwhile, the left eye falling edge LFT of the shutter control signal must be earlier than the finishing point of the light emitting period 4 of the second field OFD. That is, as the reset period 1 of the right-eye image frame 2FOR starts after, e.g., immediately after, the light emitting period 4 of the left-eye image frame 1FOL of the second field OFD, the left eye falling edge LFT of the shutter control signal is controlled to have the time t3 before the reset period 1 starts. Thus, closing of the left eye shutter starts closing at time t3 and finishes its closing during the period T2. At this time, in contrast, the right eye shutter of the shutter spectacles receives the shutter control signal and is opened through the period T3. Like the case of the left eye shutter, the right eye shutter is also delayed by the period T3 by the response speed in the opening process such that the point of time of the left eye falling edge LFT of the shutter control signal must be controlled, and thereby the right eye shutter may be completely opened before the point of time t4 as the start time of the light emitting period 4 of the first field EFD among the right-eye image frame.

Accordingly, the left eye falling edge LFT may be controlled before the point of time t4. That is, the stereoscopic display system of the example embodiments may control the left eye falling edge LFT of the shutter control signal to be at least earlier than the finishing point of the light emitting period 4 of the second field OFD. Accordingly, the image is recognized by the left eye shutter in a state in which a portion of the period P1 of the light emitting period 4 of the second field (OFD) is lost.

Accordingly, in the stereoscopic display system of the example embodiments, the shutter control signal may be controlled to give up a portion of the periods P1 and P2 of the light emitting period 4 of the second field OFD, thereby compensating for the luminance difference along with the light emitting period of the first field EFD.

In other words, according to a conventional shutter spectacle driving method, when differentiating the light emitting for the pixel area, the light emitting of any one pixel area is lost due to the response speed of the shutter spectacles, e.g., due to delay, such that the luminance difference between pixel areas is generated. In such a conventional stereoscopic display system, when displaying one stereoscopic image by combining the images for the pixel areas, the luminance difference for the pixel area may cause a significant image quality deterioration. Referring to the exemplary embodiment shown in the picture of FIG. 3, however, when opening and closing the shutter spectacles in synchronization with the start or the finishing point of the light emitting period of the first field EFD and the light emitting period of the second field OFD in the left-eye image frames 1FEL and 1FOL, and the light emitting period of the first field EFD and the light emitting period of the second field OFD in the right-eye image frame 2FER and 2FOR, the loss of the light emitting periods of the first field EFD is only generated due to the response speed of the spectacles. Therefore, the luminance difference of the light emitting of the first field EFD and the light emitting of the second field OFD is generated, thereby deteriorating the image quality of the stereoscopic image.

According to an exemplary embodiment, however, the shutter control signal is controlled to control the timing of the opening and closing of the shutter spectacle, such that the light emitting amount of the first field EFD and the light emitting amount of the second field OFD may be balanced.

Referring to the timing diagram of the stereoscopic display system of another exemplary embodiment, as illustrated in FIG. 5, it may be confirmed that the luminance imbalance of the light emitting of the first field EFD and the second field OFD is compensated by the driving control of the example embodiments.

Particularly, FIG. 5 shows the timing diagram in which two repeated image frames of 1 frame and 2 frame are temporarily arranged and the scan period and the light emitting period of the first field and the second field are only enlarged.

In detail, referring to FIG. 5, if the left eye image data signal of the first field is written to the scan period 1-image EL during the first image frame (1 frame), the left-eye image is displayed to the pixel corresponding to the first field of the display unit during the light emitting period 1-EL of the left-eye image. The light emitting of the right-eye image of the first field is realized through the scan period 1-image ER of the first field and the light emitting period 1-ER of the right-eye image.

The driving of the second field driven with the disparity by the predetermined period for the first field is also the same. That is, if the left eye image data signal is written during the scan period 1-image OL of the second field, the left-eye image is displayed to the pixel corresponding to the second field of the display unit during the light emitting period 1-OL of the left-eye image. The light emitting of the right-eye image of the second field is also realized through the scan period 1-image OR of the second field and the light emitting period 1-OR of the right-eye image.

In a case of the shutter spectacles EX I driven according to the shutter control signal of the stereoscopic display system according to the exemplary embodiment of FIG. 5, the point of time of the left eye shutter is between the point of time t10 as the point of time earlier from the finishing point of the second field light emitting period 1-OL of the left-eye image frame by the predetermined period and the point of time t20 as the finishing point. Next, the point of time when the right eye shutter is opened is after the point of time t20 before the start time of the first field light emitting period 1-ER of the right-eye image frame. The left eye shutter and the right eye shutter of the shutter spectacles EX1 may be respectively controlled to be repeatedly closed before the light emitting of the image at one view point is finished and to be repeatedly opened before the light emitting of the image at the other view point is started.

Meanwhile, in a case of the shutter spectacles EX2 driven according to the shutter control signal of the stereoscopic display system according to another exemplary embodiment of FIG. 5, the point of time when the left eye shutter is closed is the point of time t10 as the point of time earlier than the finishing point of the second field light emitting period 1-OL of the left-eye image frame by the predetermined period. Next, the point of time when the right eye shutter is opened is the point of time t20 as the finishing point of the second field light emitting period 1-OL of the left-eye image frame. The left eye shutter and the right eye shutter of the shutter spectacles EX2 may be respectively controlled to be repeatedly closed before the light emitting of the image of one view point and to be repeatedly opened directly after the light emitting of the image of one view point. In the exemplary embodiment of the shutter spectacles EX2, the point of time when the left eye shutter or the right eye shutter is opened may not overlap the light emitting period of the previous image and must be at least directly after the light emitting of the previous image is finished.

When controlling the opening and closing of the shutter spectacles through the exemplary embodiment of FIG. 3 and FIG. 5, a portion of the light emitting period before the finishing point among the light emitting period of one pixel area is given up to compensate for the luminance difference relative to the other pixel area, thereby preventing the deterioration of the stereoscopic image quality.

The drawings and the detailed description of the invention given so far are only illustrative, and they are only used to describe the example embodiments but are not used to limit the meaning or restrict the range of the example embodiments described in the claims. Therefore, it will be appreciated to those skilled in the art that various modifications may be made and other equivalent embodiments are available. Further, a person of ordinary skill in the art may remove a part of the constituent elements described in the specification without deterioration of performance or add constituent elements to improve performance. In addition, a person of ordinary skill in the art may change the order of the steps of the method described in the specification depending on process environment or equipment. Therefore, it is intended that the scope of the invention be defined by the claims appended hereto and their equivalents.

<Description of Symbols>

| | |
|---|---|
| 100: display device | 200: shutter spectacles |
| 300: remote controller | |
| 10: display unit | 20: scan driver |
| 30: data driver | 40: power controller |
| 50: signal controller | 60: transceiver |
| 70: pixel | |

What is claimed is:

1. A stereoscopic display system, comprising:
a display device configured to display an image by dividing a first field and a second field in one image frame, the first field including a first light emitting period for light-emitting according to an image data signal of a first view point and a second light emitting period for light-emitting according to an image data signal of a second view point, and the second field including a third light emitting period for light-emitting according to a image data signal of the first view point and a fourth light emitting period for light-emitting according to an image data signal of the second view point; and
shutter spectacles having a first view point shutter and a second view point shutter, the first and second view point shutters being configured to open and close in accordance with a shutter control signal transmitted from the display device,
wherein the first view point shutter is closed earlier than a finishing point of each of the first and third light emitting periods by a first period, and
wherein the second view point shutter is closed earlier than a finishing point of each of the second and fourth light emitting periods by the first period.

2. The stereoscopic display system of claim 1, wherein:
the display device includes a first pixel group having a plurality of first pixels and a second pixel group having a plurality of second pixels, and
the first pixel group is simultaneously light-emitted during the first light emitting period and the second light emitting period, and the second pixel group is simultaneously light-emitted during the third light emitting period and the fourth light emitting period.

3. The stereoscopic display system of claim 1, wherein:
the first view point shutter is opened at or before the start time of the light emitting period that is firstly started among the first light emitting period and the third light emitting period, and
the second view point shutter is opened at or before the start time of the light emitting period that is firstly started among the second light emitting period and the fourth light emitting period.

4. The stereoscopic display system of claim 1, wherein the first period is equal to or longer than a delay time according to a response speed of the first view point shutter and the second view point shutter.

5. The stereoscopic display system of claim 1, wherein the first light emitting period and the third light emitting period do not overlap each other, and the second light emitting period and the fourth light emitting period do not overlap each other.

6. The stereoscopic display system of claim 1, wherein:
the first field further comprises a reset period for resetting an anode voltage of each organic light emitting diode (OLED) of the pixels of the first pixel area before the first light emitting period and the second light emitting period, a compensating period for compensating a threshold voltage of each driving transistor of the pixels of the first pixel area, and a scan period for transmitting the image data signal of the first view point or the image data signal of the second view point, and
the second field comprises a reset period for resetting an anode voltage of each OLED of the pixels of the second pixel area before the third light emitting period and the fourth light emitting period, a compensating period for compensating a threshold voltage of each driving transistor of the pixels of the second pixel area, and a scan period for transmitting the image data signal of the first view point or the image data signal of the second view point.

7. The stereoscopic display system of claim 6, wherein, in the first to fourth light emitting periods, a difference of voltage levels of the first power source voltage and the second power source voltage supplied to the pixels of the first pixel area or the pixels of the second pixel area is controlled differently from the remaining period to be supplied.

8. The stereoscopic display system of claim 1, wherein:
the first pixel area includes a plurality of first pixels,
the second pixel area includes a plurality of second pixels, and
the plurality of first pixels and the plurality of second pixels are alternately arranged according to a first direction and a second direction.

9. The stereoscopic display system of claim 1, wherein the display device includes a signal controller configured to generate the shutter control signal and to transmit the shutter control signal to the shutter spectacles, the shutter control signal being configured to control the opening and closing of the first view point shutter and the second view point shutter of the shutter spectacles in accordance with the start or finishing points of the first to fourth light emitting periods.

10. The stereoscopic display system of claim 9, wherein the display device further comprises a transceiver configured to exchange information with the outside through a wire or wireless communication method, the shutter control signal being transmitted to the shutter spectacles from the signal controller through the transceiver.

11. The stereoscopic display system of claim 1, wherein the display device includes:
a display unit having the first pixel area with the plurality of first pixels and the second pixel area with the plurality of second pixels, the plurality of first pixels and second pixels respectively including an organic light emitting diode (OLED) and a driving transistor controlling a driving current supplied to the OLED;
a scan driver configured to transmit a plurality of scan signals to a plurality of scan lines connected to the plurality of first pixels and second pixels;
a data driver configured to transmit the plurality of first view point image data signals and second view point image data signals to a plurality of data lines connected to the plurality of the first pixels and second pixels;
a power controller configured to control and transmit a first power source voltage and a second power source voltage as voltage for driving the plurality of first pixels and second pixels; and
a signal controller configured to control the scan driver, the data driver, and the power controller, to generate and supply the plurality of first view point image data signals and second view point image data signals to the data driver, and to generate and transmit the shutter control signal controlling the opening and closing of the first view point shutter and the second view point shutter of the shutter spectacles to the shutter spectacles.

12. The stereoscopic display system of claim 11, wherein the display device further includes a transceiver configured to receive the shutter control signal from the signal controller and to transmit the shutter control signal to the shutter spectacles through a wired or wireless communication method.

13. The stereoscopic display system of claim 1, further comprising a remote controller configured to generate a remote control signal and to transmit the remote control signal to the display device, the remote control signal being configured to adjust luminance of a displayed image of the display device to a luminance level selected by a user.

14. The stereoscopic display system of claim 13, wherein the remote control signal is transmitted to the signal controller through a transceiver of the display device, the remote control signal being configured to control a driving timing of the shutter control signal generated by the signal controller.

15. A driving control method of a stereoscopic display system including a display device having a plurality of pixels and shutter spectacles having a first view point shutter and a second view point shutter that are alternately opened and closed in accordance with a shutter control signal transmitted from the display device, the method comprising:
driving a first field sequentially including a first image period transmitting an image data signal of a first view point to pixels of the first pixel area among the plurality of pixels and simultaneously light-emitting according to the data signal, and a second image period transmitting an image data signal of a second view point and simultaneously light-emitting according to the data signal;
driving a second field sequentially including a third image period transmitting the image data signal of a first view point to pixels of the first pixel area among the plurality of pixels and simultaneously light-emitting according to the data signal, and a fourth image period transmitting the image data signal of a second view point and simultaneously light-emitting according to the data signal; and
driving the shutter spectacles such that the first view point shutter is opened at the light emitting period of the first image period and the third image period, and the second view point shutter is opened at the light emitting period of the second image period and the fourth image period,
wherein a start time of the third image period is shifted by a predetermined period after the start time of the first image period, and
wherein the first view point shutter is closed before a light emitting finishing point of the third image period by the second period, and the second view point shutter is closed before the light emitting finishing point of the fourth image period by the second period.

16. The driving control method of claim 15, wherein the second period is equal to or longer than a delay time according to a response speed of the first view point shutter and the second view point shutter.

17. The driving control method of claim 15, wherein the first image period to the fourth image period respectively include:
a reset period for resetting an anode voltage of each organic light emitting diode (OLED) of the plurality of pixels, a compensating period for compensating a threshold voltage of each driving transistor of the plurality of pixels, a scan period for transmitting the image data signal of the corresponding view point, and a light emitting period for simultaneously light-emitting the plurality of pixels according to the image data signal of the corresponding view point.

18. The driving control method of claim 17, wherein the light emitting period of the first image period and the light emitting period of the third image do not overlap each other, and the light emitting period of the second image period and the light emitting period of the fourth image do not overlap each other.

19. The driving control method of claim 17, wherein in each light emitting period of the first image period to the fourth image period, a difference of voltage levels of the first power source voltage and the second power source voltage supplied to the pixels of the first pixel area or the pixels of the second pixel area is controlled differently from the remaining period to be supplied.

20. The driving control method of claim 15, further comprising generating a remote control signal for controlling luminance of the display image of the display device as a luminance level selected by the user and transmitting the remote control signal to the display device before driving the shutter spectacles.
